(19) United States
(12) Patent Application Publication
(10) Pub. No.: US 2024/0381014 A1
(43) Pub. Date: Nov. 14, 2024

(54) SPEAKER GRILLE PASSIVELY TENSIONING ACOUSTIC FABRIC

(71) Applicant: Google LLC, Mountain View, CA (US)

(72) Inventors: Laura Shumaker, Santa Rosa, CA (US); Kenneth A. Jenks, San Jose, CA (US)

(73) Assignee: Google LLC, Mountain View, CA (US)

(21) Appl. No.: 18/657,374

(22) Filed: May 7, 2024

Related U.S. Application Data
(60) Provisional application No. 63/464,763, filed on May 8, 2023.

(51) Int. Cl. H04R 1/02; G06F 1/16; H04R 3/00

(52) U.S. Cl. CPC H04R 1/023; G06F 1/1632; H04R 1/025; H04R 1/028; H04R 3/00

(57) ABSTRACT

An audio system includes a processing module for receiving audio data information. The processing module generates an audio signal based at least partly on the received audio data information. The system further includes a speaker driver, communicatively coupled to the processing module to receive the audio signal and to generate a driving signal in response to the audio signal. The system includes a speaker assembly including a diaphragm for generating sound waves in response to the audio signal, a grille defining a plurality of holes, wherein the grille and the diaphragm collectively at least partly define a cavity therebetween, wherein a center point of the grille is convex from a perimeter of the grille, and a fabric, covering the grille, wherein the holes of the grille expose the fabric to the cavity, and wherein the fabric slidably contacts the grille along a perimeter of each of the holes.

### CROSS-REFERENCE TO RELATED APPLICATIONS

This application claims the benefit of, and priority to U.S. Provisional Application Ser. No. 63/464,763, filed May 8, 2023, which is hereby incorporated by reference in its entirety for all purposes.

### BACKGROUND

Audio systems include one or more speakers and a controller which processes an audio signal and generates a driving signal for the speakers. In response to the driving signal, the speakers generate audio waves corresponding to the driving signal. A fabric is often used to cover the speaker; however, the fabric affects the air flow in and out of the speaker and may cause distortion. Improved speakers are needed in the art.

### SUMMARY

According to one embodiment, an audio system includes a processing module for receiving audio data information. The processing module generates an audio signal based at least partly on the received audio data information. The system further includes a speaker driver, communicatively coupled to the processing module to receive the audio signal and to generate a driving signal in response to the audio signal. The system includes a speaker assembly including a diaphragm for generating sound waves in response to the audio signal, a grille defining a plurality of holes, wherein the grille and the diaphragm collectively at least partly define a cavity therebetween, wherein a center point of the grille is convex from a perimeter of the grille, and a fabric, covering the grille, wherein the holes of the grille expose the fabric to the cavity, and wherein the fabric slidably contacts the grille along a perimeter of each of the holes.

The audio system may include various optional embodiments. The fabric may contact the grille along a perimeter of each of the holes while the speaker generates a 75 dB sound output at 1 meter distance from the speaker. An air permeability of the fabric may be less than 100 cm3/s/cm2. A tension of the fabric may be less than about 30 N. A cross-section of the grille may be curved. The center point of the grille may be greater than 0.5 mm convex from the perimeter of the grille. The audio system may be integrated into a speaker device. The speaker device may be a dock of a home assistant device.

According to another embodiment, a tablet computer system includes a tablet computer and a dock including a processing module for receiving audio data information. The processing module generates an audio signal based at least partly on the received audio data information. The dock further includes a speaker driver, communicatively coupled to the processing module to receive the audio signal and to generate a driving signal in response to the audio signal and a speaker assembly including a diaphragm for generating sound waves in response to the audio signal, a grille defining a plurality of holes where the grille and the diaphragm collectively at least partly define a cavity therebetween. A center point of the grille is convex from a perimeter of the grille. The speaker assembly further includes fabric, covering the grille, where the holes of the grille expose the fabric to the cavity, and wherein the fabric slidably contacts the grille along a perimeter of each of the holes. The tablet computer is removably dockable from the dock.

The tablet computer system may include various optional embodiments. The fabric may contact the grille along a perimeter of each of the holes while the speaker generates a 75 dB sound output at 1 meter distance from the speaker. An air permeability of the fabric may be less than 100 cm3/s/cm2. A tension of the fabric may be less than about 30 N. A cross-section of the grille may be curved. The center point of the grille may be greater than 0.5 mm convex from the perimeter of the grille.

According to yet another embodiment, a method of operating an electronic speaker device includes receiving input from a user at a tablet computer docked to a dock. The dock includes an audio system including a processing module for receiving audio input from the user. The processing module generates an audio signal based at least partly on the received audio input from the user. The audio system includes a speaker driver, communicatively coupled to the processing module to receive the audio signal and to generate a driving signal in response to the audio signal and a speaker assembly including a diaphragm for generating sound waves in response to the audio signal, a grille defining a plurality of holes where the grille and the diaphragm collectively at least partly define a cavity therebetween, and a fabric, covering the grille, where the holes of the grille expose the fabric to the cavity. The fabric slidably contacts the grille along a perimeter of each of the holes. A center point of the grille is greater than 0.5 mm convex from a perimeter of the grille. The method further includes generating audio output in response to the input from the user and generating sound waves from the dock for outputting the audio output, the sounds waves based at least in part on the audio signal and the driving signal. The fabric and the grille of the dock remain in contact as the sound waves are generated.

The method may include various optional embodiments. The fabric may contact the grille along a perimeter of each of the holes while the speaker generates a 75 dB sound output at 1 meter distance from the speaker. An air permeability of the fabric may be less than 100 cm3/s/cm2. A tension of the fabric may be less than about 30 N. A cross-section of the grille may be curved. The tablet computer may be removably dockable to the dock.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of an embodiment of an audio device.

FIG. 2 illustrates a smart home environment that includes various smart-home devices which can produce audio signals.

FIG. 3 illustrates a speaker according to some embodiments.

FIG. 4 illustrates a speaker according to some embodiments.

FIG. 5 illustrates a tablet connected to a tablet base having a speaker according to some embodiments.

FIG. 6 illustrates a speaker grille according to some embodiments.

FIG. 7 illustrates a speaker grille according to some embodiments.

FIG. 8 illustrates a method of using an audio system according to some embodiments.

### DETAILED DESCRIPTION

Textiles are the most common choice of covering for speakers and there is an ongoing desire to fit more powerful speakers behind the textiles, leading to potential audio distortion. A speaker assembly may include a magnet, a coil, a diaphragm, a surround, a grille, and a fabric or textile covering. Textile coverings for speakers provide a cosmetic surface that blends into home aesthetics, protection over the speaker driver from ingress of blunt objects, and the opportunity for brand expression. However, opaque textiles (necessary to be a pleasing cosmetic surface) can significantly restrict airflow from the speaker driver. Moving air then causes the textile to flutter, impacting the plastic grille surface and causing acoustic distortion that is perceptible to users. Curved grilles constrain the textile geometrically, only allowing it to move freely over the grille holes. In contrast, flat grille surfaces without any bonding between the textile and the grille allow the textile to move as a large “drumhead.” A large expanse of textile is generally less stiff than a very small one, and can thus move more easily, greatly increasing the risk of acoustic distortion.

Some designs use flat grilles with small areas necessitating that the maximum area of that grille be open holes rather than plastic ribs to ensure low airflow velocities off of the driver. Narrow plastic ribs are particularly difficult to apply adhesive to, in order to bond and constrain the textile. Textiles may be bonded and constrained by applying thin films of adhesive or sprayed on adhesive to textile. However, this process may add cost and increase the likelihood of defects.

The present disclosure describes a speaker grille for passively tensioning acoustic fabric to an electronic-speaker device. The audio system described herein gently arches or bows a plastic grille surface outwards. The textile will be stretched over the surface of the plastic grille such that the textile is convex enough to keep the textile strained, even when driven by airflow from the speaker, while also maintaining a flat appearance that may be desirable for aesthetic purposes. For example, according to various embodiments, a center point of the grille is greater than 0.5 mm convex from a perimeter of the grille.

In some embodiments, the audio system described herein is part of a tablet computer system. Specifically, a tablet computer can serve as a home assistant device and/or hub to manage smart home devices in an environment and the tablet may be docked to a dock including the audio system for outputting audio to a user. The tablet computer may be able to record video, communicate with a remote server system, and interact with users via spoken communications. For example, a home assistant device may provide automated control or voice control of devices, appliances, and systems, such as heating, ventilation, and air conditioning (“HVAC”) system, lighting systems, home theater, entertainment systems, as well as security systems. Smart home networks may include control panels that a person may use to input settings, preferences, and scheduling information that the smart home network uses to provide automated control of the various devices, appliances, and systems in the home. For example, the person may input a schedule indicating when the person is away from the home, and the smart home network uses this information along with information obtained from various devices in the home to detect unauthorized entry when the user is away. The tablet computer may be left docked with a dock to charge its battery and use other features of the dock, such as an integrated speaker. The tablet computer may be removed from the dock for convenience to be used or displayed at another location. When not in use (whether docked, not docked, or both), photos or photo albums selected by a user may be presented by the tablet.

Many other types of electronic devices can benefit from audio system described herein. For example, smartphones, gaming devices, e-readers, personal digital assistants (PDAs), digital paper tablets, and smart picture frames may benefit from various embodiments of audio system described herein. Furthermore, the electronic device may be an assistant device (e.g., Google® Nest® Hub; Google® Nest® Hub Max); a home automation controller (e.g., controller for an alarm system, thermostat, lighting system, door lock, motorized doors, etc.); a gaming device (e.g., a gaming system, gaming controller, data glove, etc.); a communication device (e.g., a smart phone such as a Google® Pixel® Phone, cellular phone, mobile phone, wireless phone, portable phone, radio telephone, etc.); and/or other computing device (e.g., a tablet computer, phablet computer, notebook computer, laptop computer, etc.).

As understood by those of skill in the art, speakers, for example included in an audio system of a smart home device, are driven by a processing module, which generates driving signals which are transmitted to the speakers. The speakers receive the driving signals and mechanically respond with the driving signals by moving an audio generation element. In addition, the movement of the audio generation element causes sound or audio compression waves to propagate from the audio generation element as an audio signal.

In some embodiments, the grille is gently arched or bowed outwards. The textile is stretched over this surface, and it is convex enough to keep the textile under tension, even when driven by airflow from the speaker. However, the grille will be close enough to flat, for example, at least for space usage and geometric compatibility reasons.

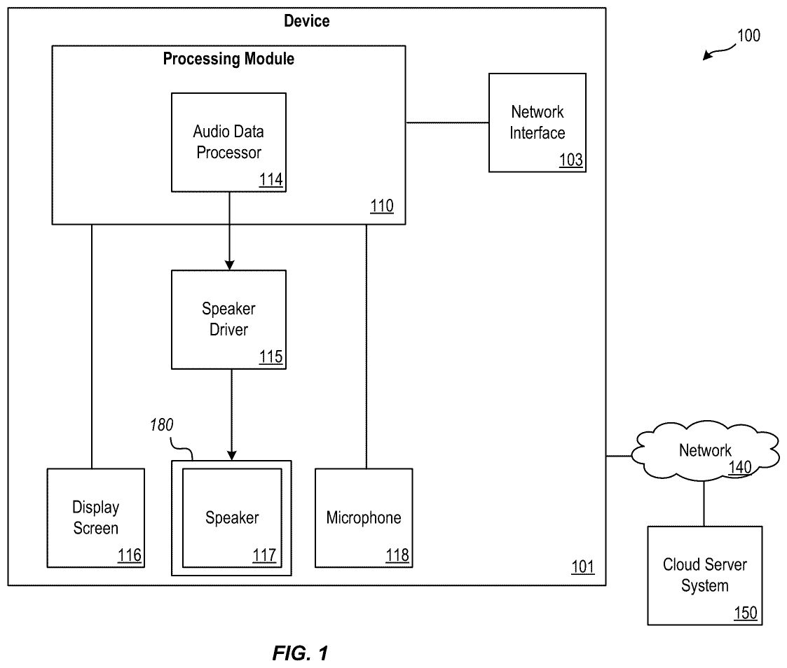

FIG. 1 illustrates a block diagram of an embodiment of an audio system 100. Audio system 100 (“system 100”) can include: device 101, which may or may not, for example, be a smart-home device; network 140; and cloud server system 150.

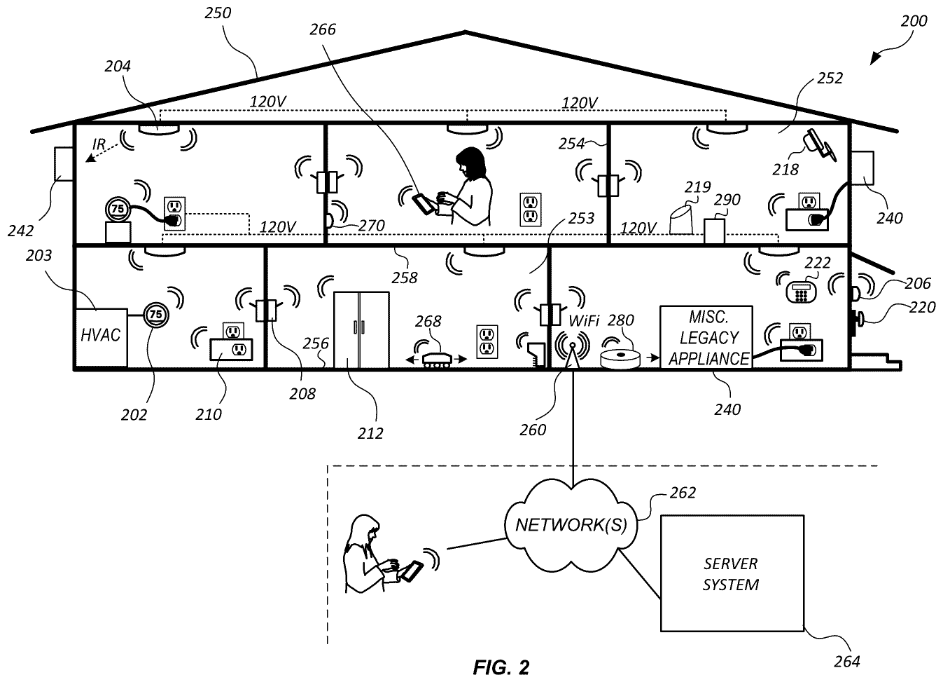

Device 101 may, for example, be any of various types of devices having a speaker, such as a smart home assistant device that can respond to spoken queries from persons nearby. A smart home assistant device may selectively or continuously listen for a spoken passphrase, which triggers the smart home assistant device to capture and analyze a spoken query. Various forms of smart-home devices which can function as device 101 are detailed in relation to FIG. 2. In other embodiments, the audio processing components 114 and 115 may be incorporated into an electronic device other than a smart-home device. In some embodiments, device 101 is not a smart-home device.

Device 101 can include, for example: network interface 103, processing module 110, speaker driver 115, display screen 116, speaker 117, and microphone 118. As illustrated, speaker 117 has a fabric 180, which is tensioned around at least a portion thereof. Example properties of the fabric 180 and its configuration with respect to speaker 117 are discussed in further detail below.

Processing module 110 can represent a monolithic integrated circuit. Therefore, all components of processing module 110 may be implemented within a single package that can be affixed to a printed circuit board of device 101. In addition to other modules, for example, understood by those of skill in the art, processing module 110 may include audio processing components, such as audio data processor 114, and one or more circuits configured to receive and process signals from microphone 118.

In some embodiments, the monolithic integrated circuit also includes speaker driver 115.

Audio data processor 114 may be configured to receive audio data information, for example, from a memory (not shown), from network interface 103, and/or from one or more other sources. Based at least partly on the received audio data information, audio data processor 114 may be configured to generate a digital audio signal for speaker driver 115. Using techniques and/or components having functionality understood by those of skill in the art, audio data processor 114 may, for example, perform audio processing functions such as volume or gain control, equalization, and or one or more other functions known to those of skill in the art. Audio data processor 114 may include, for example, digital processing elements such as filters, amplifiers, time to frequency domain converters, frequency to time domain converters, and other digital circuits, for example, known to those of skill in the art.

Speaker driver 115 is configured to receive the digital audio signal from audio data processor 114. Based at least partly on the digital audio signal, speaker driver 115 is configured to generate a driving signal for speaker 117. Using techniques and/or components having functionality understood by those of skill in the art, speaker driver 115 may, for example, convert the digital audio signal into an analog audio signal and to generate the driving signal for speaker 117 based at least partly on the analog audio signal. In some embodiments, speaker driver 115 may be configured to, for example, perform audio processing functions such as volume or gain control, equalization, and/or one or more other functions known to those of skill in the art. Speaker driver 115 may include, for example, analog processing elements such as one or more digital to analog converters, filters, amplifiers, and other analog circuits, for example, known to those of skill in the art.

Speaker 117 is configured to receive the driving signal from speaker driver 115. Based at least partly on the received driving signal, using an audio generation element understood by those of skill in the art, speaker 117 is configured to generate compression sound waves, for example, as audible sounds.

In some embodiments, system 100 includes a monolithic IC that performs all of the audio functions described herein, and in other embodiments, the components of processing module 110 performing the described functions may be split among multiple components or chips or packages.

Device 101 can include network interface 103. Network interface 103 can allow device 101 to communicate via one or more wired and/or wireless networks. For instance, network interface 103 may allow device 101 to communicate via a wireless local area network, such as a wireless network that operates in accordance with an IEEE 802.11 standard. Network interface 103 may also communicate via one or more mesh networking protocols, such as Thread, Zigbee, or Z-Wave.

Network interface 103 may permit device 101 to communicate with network 140. Network 140 can include one or more private and/or public networks, such as the Internet. Network 140 may be used such that device 101 can communicate with the cloud server system 150. Cloud server system 150 may, in some embodiments, perform some of the processing functions described herein as being performed by processing module 110. Additionally, or alternatively, cloud server system 150 may be used to relay notifications and/or store data produced by device 101 for example, in association with a user account.

Display screen 116, speaker 117, and microphone 118 may permit device 101 to interact with persons nearby. Display screen 116 may be a touchscreen display that presents information pertinent to other smart-home devices that have been linked with device 101 and results obtained in response to a query posed by user via microphone 118. In some embodiments, device 101 may not have display screen 116. For instance, some forms of smart home assistants, which respond to auditory queries, use speech as the primary input and output interfaces. In some embodiments, display screen 116 is or includes lights, such as light emitting diodes electrically connected to a processor such as processing module 110 which causes the lights to emit light as an indication of a mode of operation of the audio system 100.

Microphone 118 can be used for a person to pose a spoken query to device 101. The spoken query may be analyzed locally or may be transmitted by device 101 to cloud server system 150 for analysis. A result of the spoken query may be transmitted back to device 101 by cloud server system 150 to be output via speaker 117 using recorded or synthesized speech. Speaker 117 and microphone 118 may further be used to interact with a person.

Processing module 110 may include one or more special-purpose or general-purpose processors. Such special-purpose processors may include processors that are specifically designed to perform the functions detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD). The components that are presented as part of processing module 110 can be implemented as individual hardware and/or software components or may be implemented together, such as in the form of software that is executed by one or more processors.

FIG. 2 illustrates an embodiment of a smart home environment 200 in which various smart-home devices may include the componentry of device 101 to perform the functions described herein. Various smart-home devices, including those located indoors or outdoors, may benefit from the ability to perform the functions described herein.

The smart home environment 200 includes a structure 250 (e.g., a house, daycare, office building, apartment, condominium, garage, or mobile home) with various integrated devices. It will be appreciated that devices may also be integrated into a smart home environment 200 that does not include an entire structure 250, such as an apartment or condominium. Further, the smart home environment 200 may control and/or be coupled to devices outside of the actual structure 250. Indeed, several devices in the smart home environment 200 need not be physically within the structure 250.

It is to be appreciated that “smart home environments” may refer to smart environments for homes such as a single-family house, but the scope of the present teachings is not so limited. The present teachings are also applicable, without limitation, to duplexes, townhomes, multi-unit apartment buildings, hotels, retail stores, office buildings, industrial buildings, and more generally any living space or workspace.

It is also to be appreciated that while the terms user, customer, installer, homeowner, occupant, guest, tenant, landlord, repair person, and the like may be used to refer to the person or persons acting in the context of some particular situations described herein, these references do not limit the scope of the present teachings with respect to the person or persons who are performing such actions. Thus, for example, the terms user, customer, purchaser, installer, subscriber, and homeowner may often refer to the same person in the case of a single-family residential dwelling, because the head of the household is often the person who makes the purchasing decision, buys the unit, and installs and configures the unit, and is also one of the users of the unit. However, in other scenarios, such as a landlord-tenant environment, the customer may be the landlord with respect to purchasing the unit, the installer may be a local apartment supervisor, a first user may be the tenant, and a second user may again be the landlord with respect to remote control functionality. Importantly, while the identity of the person performing the action may be germane to a particular advantage provided by one or more of the implementations, such identity should not be construed in the descriptions that follow as necessarily limiting the scope of the present teachings to those particular individuals having those particular identities.

The depicted structure 250 includes a plurality of rooms 252, separated at least partly from each other via walls 254. The walls 254 may include interior walls or exterior walls. Each room may further include a floor 256 and a ceiling 258. Devices may be mounted on, integrated with and/or supported by a wall 254, floor 256 or ceiling 258.

In some implementations, the integrated devices of the smart home environment 200 include intelligent, multi-sensing, network-connected devices that integrate seamlessly with each other in a smart home network and/or with a central server or a cloud-computing system to provide a variety of useful smart home functions. The smart home environment 200 may include one or more intelligent, multi-sensing, network-connected thermostats 202 (hereinafter referred to as “smart thermostats 202”), one or more intelligent, network-connected, multi-sensing hazard detection units 204 (hereinafter referred to as “smart hazard detectors 204”), one or more intelligent, multi-sensing, network-connected entryway interface devices 206 and 220 and one or more intelligent, multi-sensing, network-connected alarm systems 222 (hereinafter referred to as “smart alarm systems 222”). Each of these devices may have the functionality of device 101 incorporated.

In some implementations, the one or more smart thermostats 202 detect ambient climate characteristics (e.g., temperature and/or humidity) and control an HVAC system 203 accordingly. For example, a respective smart thermostats 202 includes an ambient temperature sensor.

A smart hazard detector may detect smoke, carbon monoxide, and/or some other hazard present in the environment. The one or more smart hazard detectors 204 may include thermal radiation sensors directed at respective heat sources (e.g., a stove, oven, other appliances, a fireplace, etc.). For example, a smart hazard detector 204 in a kitchen 253 includes a thermal radiation sensor directed at a network-connected appliance 212. A thermal radiation sensor may determine the temperature of the respective heat source (or a portion thereof) at which it is directed and may provide corresponding black-body radiation data as output.

The smart doorbell 206 and/or the smart door lock 220 may detect a person's approach to or departure from a location (e.g., an outer door), control doorbell/door locking functionality (e.g., receive user inputs from a portable electronic device 266-1 to actuate the bolt of the smart door lock 220), announce a person's approach or departure via audio or visual means, and/or control settings on a security system (e.g., to activate or deactivate the security system when occupants go and come). In some implementations, the smart doorbell 206 includes some or all of the components and features of the camera 218-1. In some implementations, the smart doorbell 206 includes a camera 218-1, and, therefore, is also called “doorbell camera 206” in this document. Cameras 218-1 and/or 218-2 may function as a streaming video camera and the streaming audio device detailed in relation to various embodiments herein. Cameras 218 may be mounted in a location, such as indoors and to a wall or can be moveable and placed on a surface, such as illustrated with camera 218-2. Various embodiments of cameras 218 may be installed indoors or outdoors. Each of these types of devices may have the functionality of device 101 incorporated.

The smart alarm system 222 may detect the presence of an individual within close proximity (e.g., using built-in IR sensors), sound an alarm (e.g., through a built-in speaker, or by sending commands to one or more external speakers), and send notifications to entities or users within/outside of the smart home environment 200. In some implementations, the smart alarm system 222 also includes one or more input devices or sensors (e.g., keypad, biometric scanner, NFC transceiver, microphone) for verifying the identity of a user, and one or more output devices (e.g., display, speaker). In some implementations, the smart alarm system 222 may also be set to an armed mode, such that detection of a trigger condition or event causes the alarm to be sounded unless a disarming action is performed. Each of these devices may have the functionality of device 101 incorporated.

In some implementations, the smart home environment 200 includes one or more intelligent, multi-sensing, network-connected wall switches 208 (hereinafter referred to as “smart wall switches 208”), along with one or more intelligent, multi-sensing, network-connected wall plug interfaces 210 (hereinafter referred to as “smart wall plugs 210”). The smart wall switches 208 may detect ambient lighting conditions, detect room-occupancy states, and control a power and/or dim state of one or more lights. In some instances, smart wall switches 208 may also control a power state or speed of a fan, such as a ceiling fan. The smart wall plugs 210 may detect occupancy of a room or enclosure and control the supply of power to one or more wall plugs (e.g., such that power is not supplied to the plug if nobody is at home). Each of these types of devices may have the functionality of device 101 incorporated.

In some implementations, the smart home environment 200 of FIG. 2 includes a plurality of intelligent, multi-sensing, network-connected appliances 212 (hereinafter referred to as “smart appliances 212”), such as refrigerators, stoves, ovens, televisions, washers, dryers, lights, stereos, intercom systems, wall clock, garage-door openers, floor fans, ceiling fans, wall air conditioners, pool heaters, irrigation systems, security systems, space heaters, window AC units, motorized duct vents, and so forth. Each of these devices may have the functionality of device 101 incorporated. In some implementations, when plugged in, an appliance may announce itself to the smart home network, such as by indicating what type of appliance it is, and it may automatically integrate with the controls of the smart home. Such communication by the appliance to the smart home may be facilitated by either a wired or wireless communication protocol. The smart home may also include a variety of non-communicating legacy appliances 240, such as old conventional washer/dryers, refrigerators, and the like, which may be controlled by smart wall plugs 210. The smart home environment 200 may further include a variety of partially communicating legacy appliances 242, such as infrared (“IR”) controlled wall air conditioners or other IR-controlled devices, which may be controlled by IR signals provided by the smart hazard detectors 204 or the smart wall switches 208.

In some implementations, the smart home environment 200 includes one or more network-connected cameras 218 that are configured to provide video monitoring and security in the smart home environment 200. The cameras 218 may be used to determine occupancy of the structure 250 and/or particular rooms 252 in the structure 250, and thus may act as occupancy sensors. For example, video captured by the cameras 218 may be processed to identify the presence of an occupant in the structure 250 (e.g., in a particular room 252). Specific individuals may be identified based, for example, on their appearance (e.g., height, face) and/or movement (e.g., their walk/gait). Cameras 218 may additionally include one or more sensors (e.g., IR sensors, motion detectors), input devices (e.g., microphone for capturing audio), and output devices (e.g., speaker for outputting audio). In some implementations, the cameras 218 are each configured to operate in a day mode and in a low-light mode (e.g., a night mode). In some implementations, the cameras 218 each include one or more IR illuminators for providing illumination while the camera is operating in the low-light mode. In some implementations, the cameras 218 include one or more outdoor cameras. In some implementations, the outdoor cameras include additional features and/or components such as weatherproofing and/or solar ray compensation. Such cameras may have the functionality of device 101 incorporated.

The smart home environment 200 may additionally or alternatively include one or more other occupancy sensors (e.g., the smart doorbell 206, smart door locks 220, touch screens, IR sensors, microphones, ambient light sensors, motion detectors, smart nightlights 270, etc.). In some implementations, the smart home environment 200 includes radio-frequency identification (RFID) readers (e.g., in each room 252 or a portion thereof) that determine occupancy based on RFID tags located on or embedded in occupants. For example, RFID readers may be integrated into the smart hazard detectors 204. Each of these devices may have the functionality of device 101 incorporated.

Smart home assistant 219 may have one or more microphones that continuously listen to an ambient environment. Smart home assistant 219 may be able to respond to verbal queries posed by a user, possibly preceded by a triggering phrase. Smart home assistant 219 may stream audio and, possibly, video if a camera is integrated as part of the device, to a cloud-based server system 264 (which represents an embodiment of cloud-based host system 100 of FIG. 2). Smart home assistant 219 may be a smart device through which non-auditory discomfort alerts may be output and/or an audio stream from the streaming video camera can be output. As previously noted, smart home assistant 219 may have the functionality of device 101 incorporated.

By virtue of network connectivity, one or more of the smart-home devices of FIG. 2 may further allow a user to interact with the device even if the user is not proximate to the device. For example, a user may communicate with a device using a computer (e.g., a desktop computer, laptop computer, or tablet) or another portable electronic device 266 (e.g., a mobile phone, such as a smart phone). A webpage or application may be configured to receive communications from the user and control the device based on the communications and/or to present information about the device's operation to the user. For example, the user may view a current set point temperature for a device (e.g., a stove) and adjust it using a computer. The user may be in the structure during this remote communication or outside the structure.

As discussed above, users may control smart devices in the smart home environment 200 using a network-connected computer or portable electronic device 266. In some examples, some or all of the occupants (e.g., individuals who live in the home) may register their portable electronic device 266 with the smart home environment 200. Such registration may be made at a central server to authenticate the occupant and/or the device as being associated with the home and to give permission to the occupant to use the device to control the smart devices in the home. An occupant may use their registered portable electronic device 266 to remotely control the smart devices of the home, such as when the occupant is at work or on vacation. The occupant may also use their registered device to control the smart devices when the occupant is actually located inside the home, such as when the occupant is sitting on a couch inside the home. It should be appreciated that instead of or in addition to registering portable electronic devices 266, the smart home environment 200 may make inferences about which individuals live in the home and are therefore occupants and which portable electronic devices 266 are associated with those individuals. As such, the smart home environment may “learn” who is an occupant and permit the portable electronic devices 266 associated with those individuals to control the smart devices of the home.

In some implementations, in addition to containing processing and sensing capabilities, smart thermostat 202, smart hazard detector 204, smart doorbell 206, smart wall switch 208, smart wall plug 210, network-connected appliances 212, camera 218, smart home assistant 219, smart door lock 220, and/or smart alarm system 222 (collectively referred to as “the smart-home devices”) are capable of data communications and information sharing with other smart devices, a central server or cloud-computing system, and/or other devices that are network-connected. Data communications may be carried out using any of a variety of custom or standard wireless protocols (e.g., IEEE 802.15.4, Wi-Fi, ZigBee, 3LoWPAN, Thread, Z-Wave, Bluetooth Smart, ISA100.5A, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

In some implementations, the smart devices serve as wireless or wired repeaters. In some implementations, a first one of the smart devices communicates with a second one of the smart devices via a wireless router. The smart devices may further communicate with each other via a connection (e.g., network interface 260) to a network, such as the Internet. Through the Internet, the smart devices may communicate with a cloud-based server system 264 (also called a cloud-based server system, central server system, and/or a cloud-computing system herein). Cloud-based server system 264 may be associated with a manufacturer, support entity, or service provider associated with the smart device(s). In some implementations, a user is able to contact customer support using a smart device itself rather than needing to use other communication means, such as a telephone or Internet-connected computer. In some implementations, software updates are automatically sent from cloud-based server system 264 to smart devices (e.g., when available, when purchased, or at routine intervals).

In some implementations, the network interface 260 includes a conventional network device (e.g., a router), and the smart home environment 200 of FIG. 2 includes a hub device 280 that is communicatively coupled to the network(s) 262 directly or via the network interface 260. The hub device 280 is further communicatively coupled to one or more of the above intelligent, multi-sensing, network-connected devices (e.g., smart devices of the smart home environment 200). Each of these smart devices optionally communicates with the hub device 280 using one or more radio communication networks available at least in the smart home environment 200 (e.g., ZigBee, Z-Wave, Insteon, Bluetooth, Wi-Fi and other radio communication networks). In some implementations, the hub device 280 and devices coupled with/to the hub device can be controlled and/or interacted with via an application running on a smart phone, household controller, laptop, tablet computer, game console or similar electronic device. In some implementations, a user of such controller application can view the status of the hub device or coupled smart devices, configure the hub device to interoperate with smart devices newly introduced to the home network, commission new smart devices, and adjust or view settings of connected smart devices, etc. In some implementations the hub device extends capabilities of low capability smart devices to match capabilities of the highly capable smart devices of the same type, integrates functionality of multiple different device types—even across different communication protocols—and is configured to streamline adding of new devices and commissioning of the hub device. In some implementations, hub device 280 further includes a local storage device for storing data related to, or output by, smart devices of smart home environment 200. In some implementations, the data includes one or more of: video data output by a camera device, metadata output by a smart device, settings information for a smart device, usage logs for a smart device, and the like.

In some implementations, smart home environment 200 includes a local storage device 290 for storing data related to, or output by, smart devices of smart home environment 200. In some implementations, the data includes one or more of: video data output by a camera device (e.g., cameras 218 or smart doorbell 206), metadata output by a smart device, settings information for a smart device, usage logs for a smart device, and the like. In some implementations, local storage device 290 is communicatively coupled to one or more smart devices via a smart home network. In some implementations, local storage device 290 is selectively coupled to one or more smart devices via a wired and/or wireless communication network. In some implementations, local storage device 290 is used to store video data when external network conditions are poor. For example, local storage device 290 is used when an encoding bitrate of cameras 218 exceeds the available bandwidth of the external network (e.g., network(s) 262). In some implementations, local storage device 290 temporarily stores video data from one or more cameras (e.g., cameras 218) prior to transferring the video data to a server system (e.g., cloud-based server system 264).

Further included and illustrated in the exemplary smart home environment 200 of FIG. 2 are service robots 268, each configured to carry out, in an autonomous manner, any of a variety of household tasks. For some embodiments, the service robots 268 can be respectively configured to perform floor sweeping, floor washing, etc.

In some embodiments, a service robot may follow a person from room to room and position itself such that the person can be monitored while in the room. The service robot may stop in a location within the room where it will likely be out of the way, but still has a relatively clear field-of-view of the room. Service robots 268 may have the functionality of device 101 incorporated therein. Such an arrangement may have the advantage of allowing one service robot with the functionality of device 101 incorporated to perform the functions described herein.

It will be understood that any of the speakers of the devices of the exemplary smart home environment 200 of FIG. 2 may have any combination of the various speaker features discussed, described, or referenced herein.

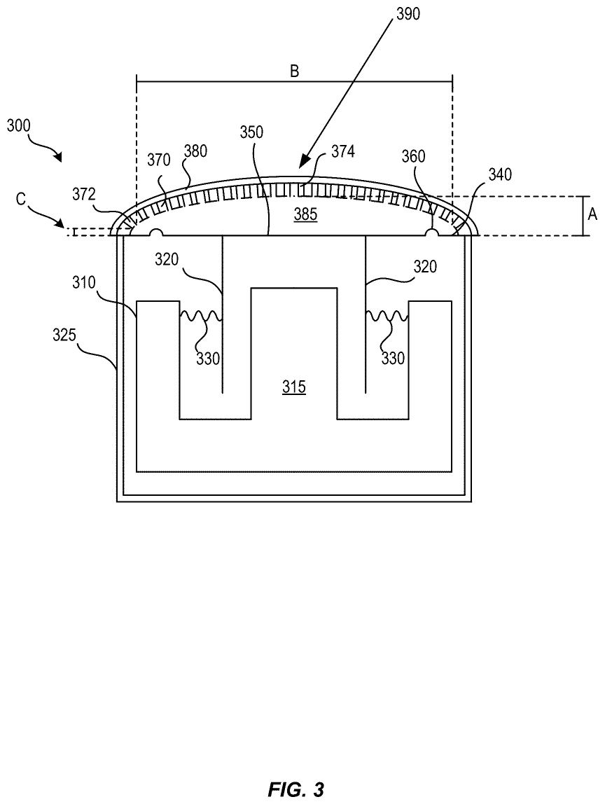

FIG. 3 illustrates a cross-section of speaker 300 at rest according to some embodiments. Speaker 300 includes a magnet 310 including magnetic pole 315, coil and coil form 320, and spider 330 within housing 325. Speaker 300 also includes anchor 340, diaphragm 350, surround 360, grille 370, and fabric 380 connected to housing 325.

The coil of the coil and coil form 320 includes a conductor that winds around the coil form. The conductor may be electrically connected with a speaker driver which provides electrical signals thereto. In response to the current of the electrical signals, the coil generates a magnetic field which interacts with the magnetic field of magnet 310 and causes a force to be exerted on the coil and coil form 320 with respect to the magnet 310. In response to the force, coil and coil form 320 moves relative to the magnet 310. Coil current traveling in a first direction generates a force which induces the coil and coil form 320 to move in an upward direction in the orientation of the figure, and coil current traveling in a second, opposite, direction generates a force which induces the coil and coil form 320 to move in a downward direction in the orientation of the figure.

The spider 330 is connected to the coil and coil form 320 and is connected to the magnet 310, for example, as illustrated. The spider 330 mechanically resists the movement of the coil and coil form 320.

The coil and coil form 320 is mechanically coupled to the diaphragm 350 such that the movement of coil and coil form 320 induces a corresponding movement in the diaphragm 350. Anchor 340 is substantially fixed with respect to magnet 310, and accordingly does not move in response to the movement of coil and coil form 320. Surround 360 is mechanically connected to anchor 340 and to diaphragm 350 and the surround 360 may conform to allow movement of the diaphragm 350 with the movement of the coil and coil form 320.

Speaker 300, as illustrated in FIG. 3, has diaphragm 350 at rest as a result of the signal received by the coil and coil form 320 not causing the coil and coil form 320 to experience an upward or a downward force, as represented by the orientation of the figure.

Grille 370 is substantially rigid and is mechanically fixed to anchor 340, which is fixed to housing 325, such that, during operation of the speaker, the sound waves and changing air pressure experienced by grille 370 do not cause or do not substantially cause grille 370 to deflect, move, or change its shape. In addition, grille 370 has holes which expose fabric 380 to a cavity 385 between diaphragm 350 and grille 370.

Fabric 380 is mechanically fixed to at least one of anchor 340, grille 370, and housing 325, and is tensioned so as to conformably contact grille 370. For example, in some embodiments, fabric 380 contacts grille 370 around the perimeter of each of one or more holes of grille 370 exposing fabric 380 to cavity 385. In some embodiments, fabric 380 contacts grille 370 around the perimeter of all of the holes of grille 370 exposing fabric 380 to cavity 385. In some embodiments, fabric 380 contacts portions of grille 370 partially or wholly surrounding each of one or more holes of grille 370 exposing fabric 380 to cavity 385. In some embodiments, fabric 380 contacts portions of grille 370 partially or wholly surrounding the perimeter of all of the holes of grille 370 exposing fabric 380 to cavity 385.

In some embodiments, fabric 380 contacts grille 370 across the illustrated cross-section as a result of tension in fabric 380. In some embodiments, fabric 380 is not glued to grille 370. In some embodiments, fabric 380 is glued to grille 370 only in a perimeter region of grille 370, for example, outside of a central region of grille 370 including the holes of grille 370. In some embodiments, fabric 380 is not glued to grille 370 inside the central region. In some embodiments, the tension of fabric 380 is sufficient that, despite the sound waves and changing air pressure experienced by fabric 380, and despite fabric 380 not being glued to grille 370, fabric 380 maintains contact with grille 370 around the entire perimeter or around part of the perimeter of each of one or more holes of grille 370 exposing fabric 380 to cavity 385 or maintains contact with grille 370 around the entire perimeter or around part of the perimeter of all of the holes of grille 370 exposing fabric 380 to cavity 385. In some embodiments, the tension of fabric 380 is sufficient that, despite the sound waves and changing air pressure experienced by fabric 380, and despite fabric 380 not being glued to a central region of grille 370 including the holes of grille 370, fabric 380 maintains contact with portions of grille 370 partially or wholly surrounding each of one or more holes of grille 370 exposing fabric 380 to cavity 385 or maintains contact with portions of grille 370 partially or wholly surrounding all of the holes of grille 370 exposing fabric 380 to cavity 385.

According to at least some embodiments, fabric 380 is not glued to any portion of grille 370. For example, fabric 380 may be mechanically attached to grille 370 using any mechanically coupling means including, but not limited to, one or more of clips, snaps, hook and loop fasteners, magnets, buttons, zippers, etc. In exemplary embodiments, fabric 380, grille 370, and the mechanically coupling means are recyclable. In various embodiments, a product including embodiments described herein may be disassembled for repair and various parts may be recycled if damaged or otherwise unusable.

In some embodiments, the fabric 380 comprises one or more elastomeric yarns. In some embodiments, the fabric 380 comprises one or more non-elastomeric yarns. In some embodiments, the fabric 380 comprises no elastomeric yarns. In some embodiments, the fabric 380 comprises no non-elastomeric yarns.

In some embodiments, the fabric 380 has an air permeability of less than 20 cm³/s/cm², 30 cm³/s/cm², 40 cm³/s/cm², 50 cm³/s/cm², 60 cm³/s/cm², 70 cm³/s/cm², 80 cm³/s/cm², 90 cm³/s/cm², 100 cm³/s/cm², 120 cm³/s/cm², 140 cm³/s/cm², 160 cm³/s/cm², 180 cm³/s/cm², 200 cm³/s/cm², 250 cm³/s/cm², 300 cm³/s/cm², 350 cm³/s/cm², 400 cm³/s/cm², 450 cm³/s/cm², 500 cm³/s/cm², or another air permeability.

In some embodiments, a tension of the fabric 380 is less than 75 N, 70 N, 65 N, 60 N, 55 N, 50 N, 45 N, 40 N, 35 N, 30 N, 25 N, 20 N, 18 N, 16 N, 14 N, 12 N, 10 N, 8 N, 6 N, 4 N, 3 N, 2 N, 1 N, or another tension.

In some embodiments, the grille 370 is sized such that dimension B is equal to 100 mm, 90 mm, 80 mm, 70 mm, 60 mm, 55 mm, 50 mm, 45 mm, 40 mm, 35 mm, 30 mm, 25 mm, 20 mm, 18 mm, 16 mm, 14 mm, 12 mm, 10 mm, or another number.

In some embodiments, the grille 370 is curved such that dimension A is less than 15 mm, 14 mm, 13 mm, 12 mm, 11 mm, 10 mm, 9 mm, 8 mm, 7 mm, 6 mm, 5 mm, 4 mm, 3 mm, 2 mm, 1 mm, 0.5 mm, 0.3 mm, 0.2 mm, 0.1 mm, or another distance.

In some embodiments, the diaphragm 350 defines a plane, for example, at least around a perimeter of the diaphragm 350, and a first hole, closest to the plane, of the grille 370 is spaced apart from the plane of the diaphragm 350 by the dimension C. In the illustrated embodiment the hole 372 is not closer to the plane than any other holes. In addition, the hole 374 of the grille 370 is spaced apart from the plane of the diaphragm 350 by the dimension A, and the hole 374 is not farther from the plane of the diaphragm 350 than any others of the holes. In some embodiments, the dimension C is less than the dimension A by less than 15 mm, 14 mm, 13 mm, 12 mm, 11 mm, 10 mm, 9 mm, 8 mm, 7 mm, 6 mm, 5 mm, 4 mm, 3 mm, 2 mm, 1 mm, 0.5 mm, 0.3 mm, 0.2 mm, or 0.1 mm.

In some embodiments, the grille 370 is curved such that a ratio of dimension A divided by dimension B is less than less than 0.5, 0.4, 0.3, 0.25, 0.2, 0.15, 0.1, 0.08, 0.06, 0.05, 0.04, 0.03, 0.02, or 0.01. Accordingly, the center point 390 of the grille 370 may be greater than 0.5 mm convex from the perimeter of the grille.

In some embodiments, the grille 370 is curved such that a ratio of the difference between dimension A and dimension C divided by dimension B ((A−C)/B) is less than 0.5, 0.4, 0.3, 0.25, 0.2, 0.15, 0.1, 0.08, 0.06, 0.05, 0.04, 0.03, 0.02, or 0.01.

In some embodiments, despite the sound waves and changing air pressure experienced by fabric 380 as a result of the speaker operating with at least 35 dB at 1 meter distance from the speaker, 40 dB at 1 meter distance from the speaker, 45 dB at 1 meter distance from the speaker, 50 dB at 1 meter distance from the speaker, 55 dB at 1 meter distance from the speaker, 60 dB at 1 meter distance from the speaker, 65 dB at 1 meter distance from the speaker, 70 dB at 1 meter distance from the speaker, 75 dB at 1 meter distance from the speaker, 80 dB at 1 meter distance from the speaker, 85 dB at 1 meter distance from the speaker, 90 dB at 1 meter distance from the speaker, 95 dB at 1 meter distance from the speaker, 100 dB at 1 meter distance from the speaker, or another power, and despite fabric 380 not being glued to a central region of grille 370 including the holes of grille 370, fabric 380 maintains contact with grille 370 around the entire perimeter or around part of the perimeter of each of one or more holes of grille 370 exposing fabric 380 to cavity 385 or maintains contact with grille 370 around the entire perimeter or around part of the perimeter of all of the holes of grille 370 exposing fabric 380 to cavity 385. In some embodiments, despite the sound waves and changing air pressure experienced by fabric 380 as a result of the speaker operating with at least 35 dB at 1 meter distance from the speaker, 40 dB at 1 meter distance from the speaker, 45 dB at 1 meter distance from the speaker, 50 dB at 1 meter distance from the speaker, 55 dB at 1 meter distance from the speaker, 60 dB at 1 meter distance from the speaker, 65 dB at 1 meter distance from the speaker, 70 dB at 1 meter distance from the speaker, 75 dB at 1 meter distance from the speaker, 80 dB at 1 meter distance from the speaker, 85 dB at 1 meter distance from the speaker, 90 dB at 1 meter distance from the speaker, 95 dB at 1 meter distance from the speaker, 100 dB at 1 meter distance from the speaker, or another power, and despite fabric 380 not being glued to a central region of grille 370 including the holes of grille 370, fabric 380 maintains contact with portions of grille 370 partially or wholly surrounding each of one or more holes of grille 370 exposing fabric 380 to cavity 385 or maintains contact with portions of grille 370 partially or wholly surrounding all of the holes of grille 370 exposing fabric 380 to cavity 385.

In some embodiments, the fabric 380 has an air permeability of less than 100 cm³/s/cm², and the tension of the fabric 380 is less than 30 N, and the grille 370 a ratio of the difference between dimension A and dimension C divided by dimension B ((A−C)/B) is less than 0.1, and, despite the sound waves and changing air pressure experienced by fabric 380 as a result of the speaker operating with 75 dB output at 1 meter distance from the speaker, and despite fabric 380 not being glued to a central region of grille 370 including the holes of grille 370, fabric 380 maintains contact with grille 370 around the entire perimeter or around part of the perimeter of each of one or more holes of grille 370 exposing fabric 380 to cavity 385 or maintains contact with grille 370 around the entire perimeter or around part of the perimeter of all of the holes of grille 370 exposing fabric 380 to cavity 385.

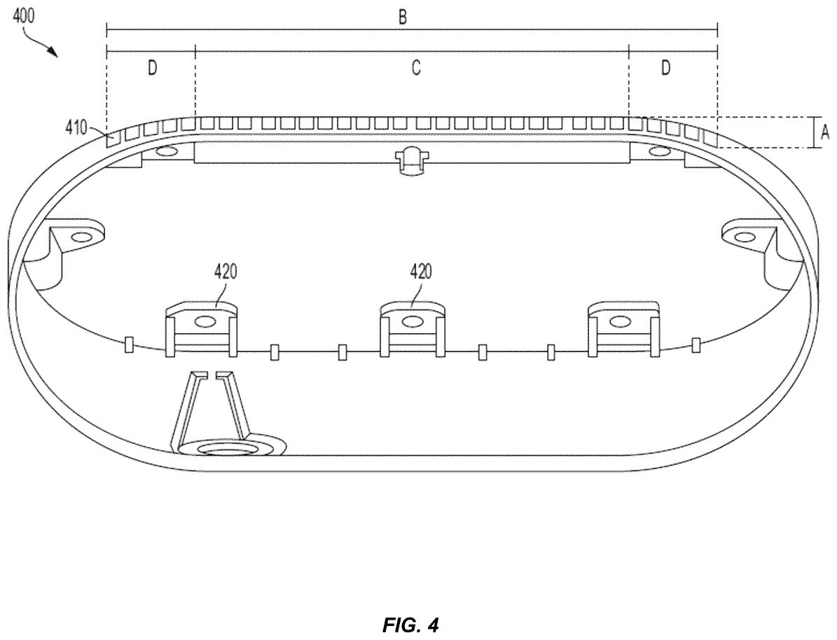

FIG. 4 illustrates a perspective view of a speaker grille 400 according to some embodiments. Speaker grille 400 may be used, for example, in a speaker having characteristics similar or identical to those discussed above with reference to speaker 300. For example, speaker grille 400 may be used as or instead of speaker grille 370 of speaker 300.

As illustrated, speaker grille 400 includes holes 410. In addition, speaker grille 400 includes a flat portion C presenting a substantially planar outer surface having some of the holes 410. Furthermore, speaker grille 400 includes curved portions D presenting curved outer surfaces having others of holes 410. In addition, speaker grille 400 has spatial dimensions A and B, which may have magnitudes and a ratio similar or identical to corresponding dimensions A and B discussed above with reference to FIG. 3.

In some embodiments, speaker grille 400 forms a housing for a magnet such as magnet 310, a coil and coil form such as coil and coil form 320, a spider such as spider 330, an anchor such as anchor 340, a diaphragm such as diaphragm 350, and a surround such as surround 360. In such embodiments, speaker grille 400 may be directly or indirectly fixed, for example, to the magnet using attachment mechanisms 420.

In some embodiments, speaker grille 400 is formed as a monolithic molded plastic piece. In other embodiments, speaker grille 400 is formed from at least two molded plastic pieces. Speaker grille 400 may include other materials, or combinations of materials, as would be appreciated by one having ordinary skill in the art upon reading the present disclosure.

In some embodiments, a fabric such as fabric 380 is placed around speaker grille 400. For example, the fabric, at rest, may form a tube having a cross-sectional area less than the corresponding cross-sectional area of speaker grille 400, and may be stretched so as to encompass speaker grille 400 such that the resulting tension of the fabric causes the fabric to maintain contact with speaker grille 400 while the speaker is operated, for example, similarly or identically to that described above with reference to speaker 300.

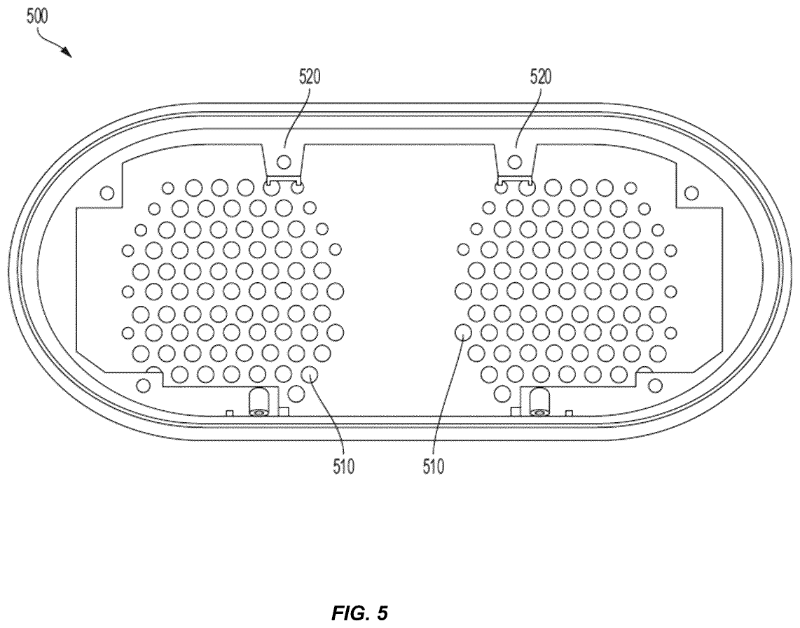

FIG. 5 illustrates a perspective view of a speaker grille 500 according to some embodiments. Speaker grille 500 may be used, for example, in a speaker having characteristics similar or identical to those discussed above with reference to speaker 300. For example, speaker grille 500 may be used as or instead of speaker grille 370 of speaker 300.

In some embodiments, speaker grille 500 forms a housing for a magnet such as magnet 310, a coil and coil form such as coil and coil form 320, a spider such as spider 330, an anchor such as anchor 340, a diaphragm such as diaphragm 350, and a surround such as surround 360. In such embodiments, speaker grille 500 may be directly or indirectly fixed, for example, to the magnet using attachment mechanisms 520.

In some embodiments, speaker grille 500 is formed as a monolithic molded plastic piece. In other embodiments, speaker grille 500 is formed from at least two molded plastic pieces. Speaker grille 500 may include other materials, or combinations of materials, as would be appreciated by one having ordinary skill in the art upon reading the present disclosure.

As illustrated, speaker grille 500 includes two sets of holes 510. In some embodiments, speaker grille 500 forms a housing for first and second speakers (not shown), each having a diaphragm aligned with one of the two sets of holes 510. However, it should be appreciated that various designs may include more or less than two sets of holes 510 for accommodating more or less than a first and second speaker. For example, three sets of holes 510 may be used for three speakers. In other embodiments, the speaker grille 500 includes a single set of holes 510 for us with one or more speakers.

In some embodiments, a fabric such as fabric 380 is coupled to speaker grille 500. For example, the fabric may be coupled to speaker grille 500 similarly or identically to the attachment of fabric 380 to grille 370 or may be coupled to speaker grille 500 similarly or identically to the attachment of the fabric to speaker grille 400 discussed above. The fabric may be attached with an adhesive, pin(s), staple(s), magnet(s), or the like, according to various embodiments.

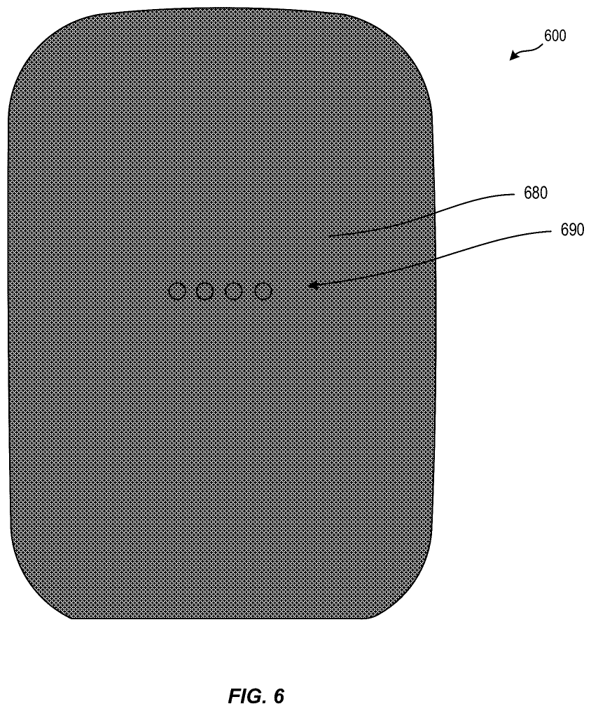

FIG. 6 illustrates an audio system 600 according to some embodiments. In this embodiment, audio system 600 may have characteristics similar or identical to those discussed above with reference to audio system 100 and/or speaker 300. In some embodiments, audio system 600 includes a speaker having a speaker grille partly or wholly forming a housing for a magnet such as magnet 310, a coil and coil form such as coil and coil form 320, a spider such as spider 330, an anchor such as anchor 340, a diaphragm such as diaphragm 350, a surround such as surround 360, and other components such as those of audio system 100.

As illustrated, audio system 600 includes a fabric 680 including one or more of the audio system components described with respect to at least FIGS. 2-5. In this embodiment, fabric 680 allows light from four lights 690 to be seen therethrough. The four lights 690 may be electrically connected to a controller which causes the four lights 690 to conditionally emit light. For example, the controller may cause the four lights 690 to emit light as an indication of a particular condition or mode of the audio system 600. For example, the audio system 600 may include a microphone such as microphone 118, and the four lights 690 may be used to indicate that the audio system 600 is monitoring audio data sensed by the microphone. According to various embodiments, any number of lights 690 may be used. The lights 690 may output any color or combination of colors for indicating notifications such as alerts or reminders or the like. The lights 690 may further blink in a patterned manner (e.g., blinking 3 times in a row and then pausing) for indicating notifications. The lights 690 may use any combination of colors, lighting patterns, or the like, as would be appreciated by one having ordinary skill in the art upon reading the present disclosure.

In some embodiments, the fabric 380 is connected to a speaker grille (not visible). For example, the fabric may be coupled to the speaker grille similarly or identically as the attachment of fabric 380 to grille 370 or may be coupled to the speaker grille similarly or identically as the attachment of the fabric to speaker grille 400 discussed above.

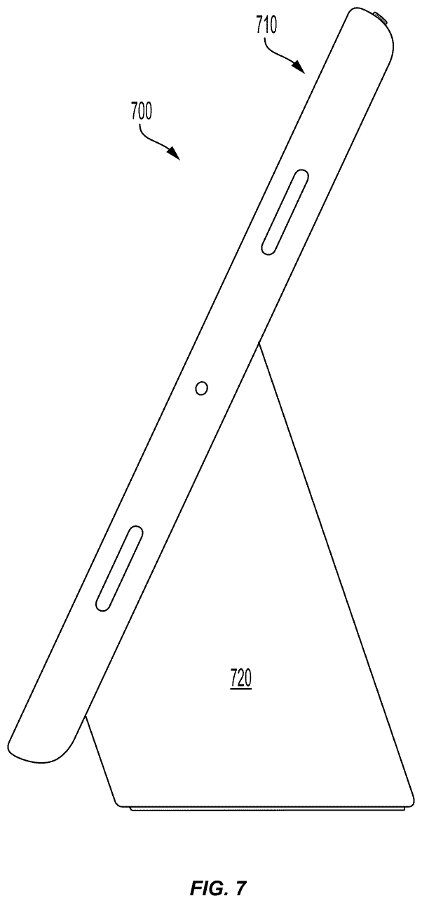

FIG. 7 illustrates a side view of a system 700 that includes an embodiment of an electronic device 710, such as a tablet or other computer. As can be seen from the side view, the electronic device 710 is docked with dock 720. The electronic device 710 may be left docked with dock 720, for example, to charge a battery of electronic device 710 and/or to use other features of the dock, such as an integrated speaker. The electronic device 710 may be removed from the dock 720 for convenience to be used or displayed at another location. In some embodiments, when not in use (whether docked, not docked, or both), photos or photo albums selected by a user may be presented by the electronic device 710. Dock 720 and electronic device 710 may each include multiple conductive contacts (e.g., metallic pads) that are used to transfer data between dock 720 and electronic device 710 and to transfer power from dock 720 to electronic device 710 when the electronic device 710 is mechanically and electrically connected to dock 720 in a docked position.

In the illustrated embodiment, dock 720 is or includes an audio system which may have characteristics similar or identical to those discussed above with reference to audio system 100, audio system 600, and/or speaker 300. For example, a front face, a back face, the sides, etc., of the dock 720 may include the fabric arranged over the curved grille as described in detail above with respect to other figures. Accordingly, the dock 720 may appear as an aesthetically pleasing speaker device that does not suffer from audio distortion.

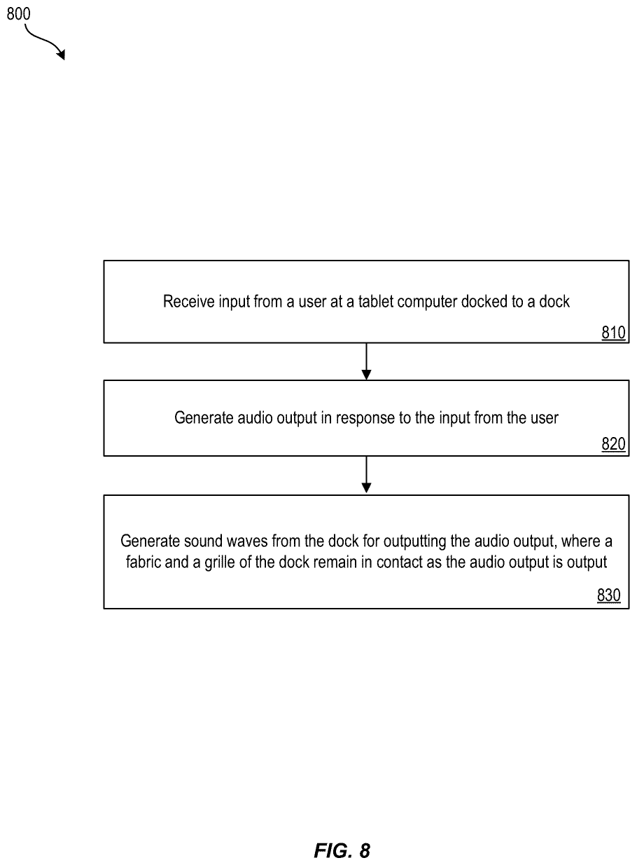

FIG. 8 illustrates a method 800 of using an audio system, such as audio system 100, comprising a speaker according to some embodiments. The speaker of the audio system may include a magnet such as magnet 310, a coil and coil form such as coil and coil form 320, a spider such as spider 330, an anchor such as anchor 340, a diaphragm such as diaphragm 350, a surround such as surround 360, a grille such as grille 370, and a fabric such as fabric 380.

Method 800 includes step 810. Step 810 includes receiving input from a user at a tablet computer docked to a dock. In various embodiments, a user may speak at the tablet computer, type onto a display of the tablet computer, or otherwise provide input to the tablet computer as would be appreciated by one having ordinary skill in the art upon reading the present disclosure. Accordingly, the input may be audio input, text input, haptic input, etc. In at least some embodiments, a user may speak at the dock itself without the tablet computer docked to the dock or with the tablet computer docked to the dock. For example, the tablet computer and the dock may each have a microphone system for receiving audio input from a user. The tablet computer and dock may form a home assistant device that the user may use to operate various smart devices, listen to audio, check reminders, etc.

Step 820 includes generating audio output in response to the input from the user. In various embodiments, the tablet computer and dock may be part of a system having a processor. The processor may process the input from the user and generate audio output in response in a manner known in the art. For example, if the user requests music to be played, the processor may generate audio output (e.g., instructions to play audio output) in response to the user's request. In various embodiments, a processor of the tablet computer receives input from the user (e.g., in the form of text input or other input means) and communicated with the processor of the dock to generate audio output (and corresponding sound waves) in response to input from the user.

Step 830 includes generating sound waves from the dock for outputting the audio output where a fabric and a grille of the dock remain in contact as the audio output is output. In various embodiments, a speaker driver provides electrical signals to a coil of a coil and coil form. In response to the current of the electrical signals, the coil generates a magnetic field which interacts with the magnetic field of the magnet and causes a force to be exerted on the coil and coil form with respect to the magnet. In response to the force, the coil and coil form moves relative to the magnet. In addition, the movement of coil and coil form induces a corresponding movement in the diaphragm. The movement of the diaphragm causes sound waves and pressure fluctuations in a cavity at least partly bounded by the diaphragm and the grille. The anchor is substantially fixed with respect to the magnet, and accordingly does not move in response to the movement of coil and coil form. The surround is mechanically connected to the anchor and to the diaphragm and conforms to allow movement of the diaphragm with the movement of the coil and coil form. Because the grille is substantially rigid and is mechanically fixed to the anchor, the sound waves and changing air pressure experienced by the grille do not cause or do not substantially cause the grille to deflect, move, or change its shape. However, holes in the grille expose the fabric to the cavity between the diaphragm and the grille.

According to step 830, the tension of the fabric is sufficient that, despite the sound waves and changing air pressure experienced by the fabric, and despite the fabric not being glued to a central region of grille including the holes of grille, the fabric maintains contact with the grille around the entire perimeter or around part of the perimeter of each of one or more holes of the grille exposing the fabric to the cavity or maintains contact with the grille around the entire perimeter or around part of the perimeter of all of the holes of the grille exposing the fabric to the cavity. In some embodiments, the tension of the fabric is sufficient that, despite the sound waves and changing air pressure experienced by the fabric, and despite the fabric not being glued to a central region of grille including the holes of grille, the fabric maintains contact with portions of the grille partially or wholly surrounding each of one or more holes of the grille exposing the fabric to the cavity or maintains contact with portions of the grille partially or wholly surrounding all of the holes of the grille exposing the fabric to the cavity.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. An audio system, comprising:
a speaker assembly, comprising:
a grille defining a plurality of holes, wherein:
the grille at least partly defines a cavity, and
a center point of the grille is convex from a perimeter of the grille; and
a fabric, covering the grille, wherein:
the holes of the grille expose the fabric to the cavity, and
the fabric slidably contacts the grille along a perimeter of each of the holes.

2. The audio system of claim 1, wherein the fabric contacts the grille along a perimeter of each of the holes while the speaker assembly generates a 75 dB sound output at 1 meter distance from the speaker assembly.

3. The audio system of claim 1, wherein an air permeability of the fabric is less than 100 cm³/s/cm².

4. The audio system of claim 1, wherein a tension of the fabric is less than about 30 N.

5. The audio system of claim 1, wherein a cross-section of the grille is curved.

6. The audio system of claim 1, wherein the center point of the grille is greater than 0.5 mm convex from the perimeter of the grille.

7. The audio system of claim 1, wherein the audio system is integrated into a speaker device.

8. The audio system of claim 7, wherein the speaker device is a dock of a home assistant device.

9. A tablet computer system comprising:
a tablet computer;
a dock, comprising:
a processing module, for receiving audio data information, wherein the processing module generates an audio signal based at least partly on the received audio data information;
a speaker driver, communicatively coupled to the processing module to receive the audio signal and to generate a driving signal in response to the audio signal; and
a speaker assembly, comprising:
a diaphragm for generating sound waves in response to the audio signal,
a grille defining a plurality of holes, wherein the grille and the diaphragm collectively at least partly define a cavity therebetween, wherein a center point of the grille is convex from a perimeter of the grille; and
a fabric, covering the grille, wherein the holes of the grille expose the fabric to the cavity, and wherein the fabric slidably contacts the grille along a perimeter of each of the holes,
wherein the tablet computer is removably dockable from the dock.

10. The system of claim 9, wherein the fabric contacts the grille along a perimeter of each of the holes while the speaker generates a 75 dB sound output at 1 meter distance from the speaker.

11. The system of claim 9, wherein an air permeability of the fabric is less than 100 cm³/s/cm².

12. The system of claim 9, wherein a tension of the fabric is less than about 30 N.

13. The system of claim 9, wherein a cross-section of the grille is curved.

14. The system of claim 9, wherein the center point of the grille is greater than 0.5 mm convex from the perimeter of the grille.

15. A method of operating an electronic speaker device comprising:
receiving input from a user at a tablet computer docked to a dock, wherein the dock comprises an audio system comprising:
a processing module, for receiving audio input from the user, wherein the processing module generates an audio signal based at least partly on the received audio input from the user;
a speaker driver, communicatively coupled to the processing module to receive the audio signal and to generate a driving signal in response to the audio signal; and
a speaker assembly, comprising:
a diaphragm for generating sound waves in response to the audio signal,
a grille defining a plurality of holes, wherein the grille and the diaphragm collectively at least partly define a cavity therebetween; and
a fabric, covering the grille, wherein the holes of the grille expose the fabric to the cavity, and wherein the fabric slidably contacts the grille along a perimeter of each of the holes, wherein a center point of the grille is greater than 0.5 mm convex from a perimeter of the grille; and
generating audio output in response to the input from the user; and
generating sound waves from the dock for outputting the audio output, the sounds waves based at least in part on the audio signal and the driving signal,
wherein the fabric and the grille of the dock remain in contact as the sound waves are generated.

16. The method of claim 15, wherein the fabric contacts the grille along a perimeter of each of the holes while the speaker generates a 75 dB sound output at 1 meter distance from the speaker.

17. The method of claim 15, wherein an air permeability of the fabric is less than 100 cm³/s/cm².

18. The method of claim 15, wherein a tension of the fabric is less than about 30 N.

19. The method of claim 15, wherein a cross-section of the grille is curved.

20. The method of claim 15, wherein the tablet computer is removably dockable to the dock.
